(19) United States
(12) Patent Application Publication
(10) Pub. No.: US 2005/0086301 A1
(43) Pub. Date: Apr. 21, 2005

(54) Systems and methods for facilitating multi-user interaction over a network

(76) Inventors: Allen J. Eichler, Waterford, VA (US); Kelton F. Flinn, Charlottesville, VA (US)

Correspondence Address: BIRCH STEWART KOLASCH & BIRCH, PO BOX 747, FALLS CHURCH, VA, 22040-0747, US

(21) Appl. No.: 10/686,677

(22) Filed: Oct. 17, 2003

(51) Int. Cl. G06F 15/16

(52) U.S. Cl. 709/204; 709/232

(57) ABSTRACT

The present invention relates generally to systems and methods for providing multi-user participation in an application over a network. The systems and methods provide for a user to affect a future virtual state of an application on a network. To do so, the system determines a safe latency. Based upon the determined safe latency, a field of influence and a field of commitment are determined. Once the field of influence and field of commitment are determined, the system permits a user input to affect a field of influence and prohibiting the user from affecting the field of commitment. Further, the system displays the virtual state of the application, wherein the virtual state includes the field of influence and field of commitment, and wherein a portion of the field of influence becomes the field of commitment after the determined safe latency has expired.

### BACKGROUND OF THE INVENTION

1. Field of the Invention

The present invention relates generally to network applications and more specifically, to systems and methods for facilitating multi-user interaction over a network.

2. Description of Related Art

Over the past decade, the popularity of on-line gaming has grown significantly. Where a number of devices are communicating over a network to participate in a game operating in a multi-user environment, the play is subject to the inefficiencies of that network. For example, when a player, through a device, wants to input information relating to a particular move, it takes some time for that information to transmit from one device to another. This time that elapses during these transmissions is referred to as network latency. Where the devices are communicating wirelessly, the network latency greatly increases.

Network latency is caused by many factors. In considering one factor, the device requires some processing time to encode and transmit data. The encoded data packets take time to travel through wires or atmosphere. If any routers process the data, each one uses additional time. Additional time is need for the data to be decoded and processed by the second device (server or other client). Depending on the protocol used, lost packets and attempts to resend data where no acknowledgement is received adds to the time it takes to communicate between devices. Further, should a device disconnect from a network, additional time is needed to reconnect.

Network latency varies greatly depending on a variety of factors. In Local Area Network environments, it is measured in tens of milliseconds. In PC/modem/dialup environments, it is generally measured in hundreds of milliseconds. In wireless environments, latency can be measured in seconds.

Multi-User Interactive Environments are software applications wherein more than one user is participating in a shared virtual environment. Examples include games (e.g., Everquest, Slingo, Quake, Ultima Online, Air Warrior, etc.), social applications (e.g., Habitat, Worlds Away, The Palace, etc.), military applications (e.g., battlefield simulators), and others. Multi-user interactive environments generally use either a peer-to-peer or client/server architecture.

In a peer-to-peer structure, there is no central server, and no arbiter for conflicts. Reality in the virtual environment is comprised of each client's reality. There are some notable drawbacks to peer-to-peer multi-user simulations. First, the client software must be given some authority over the actual virtual state. No single client will have perfect information, so truth is comprised of the collected understanding of each client. Sometimes clients will provide conflicting information. Once a client is trusted to provide accurate information, it can allow users who wish to cheat to do so by modifying their game client. Secondly, the amount of data traffic is significantly increased.

Some of the more sophisticated multi-user applications employ a client/server architecture. In this case, each end-user accesses their view on the virtual environment via client software, but a central server becomes the ultimate arbiter of the true state of the virtual environment.

In client/server systems, the client does not always present a perfect depiction of the true state of the shared virtual environment, but rather its best understanding given the available information. Similarly, client software does not always provide the end user with a direct mechanism to affect the shared environment. The client software provides the user with an interface through which he/she can attempt actions which will affect the shared environment, but the server often determines which actions it will allow and which ones it will disallow/ignore.

The server does not always trust the client to provide valid information. For example, if the application is a multi-user combat simulator, users could use client software that simulated a tank. The tank operator might adjust the inputs on his tank simulator to aim the turret towards a target, and then issue a “fire” command. When the turret was rotating, the tank client notifies the server of its actions so that the server can inform all other clients (that have line-of sight to that user's tank) so that they can accurately display the rotation of the turret. When the “fire” command is issued, the software architecture may not allow the tank client software to determine whether or not it hit the target. Instead, the server may arbitrate this event, and inform the tank client that another player destroyed the target before his shell reached the target.

To the extent that the information that is passed between clients (directly of through a server) is not complete and instantaneous, the depiction of the virtual environment will diverge between clients. As latency increases, the clients have more time to continue down disparate paths of depicting the virtual state to the user. When the server finally communicates the “true” virtual state to the clients, the clients will attempt to gracefully transition to that depiction, hopefully without adversely impacting the simulation or suspension of disbelief associated with the simulation.

As such, there is a need for a system and method that maintains a consistent representation of the virtual environment across all game clients.

### SUMMARY OF THE INVENTION

In accordance with the principles of the invention, as embodied and broadly described herein, methods and systems consistent with the principles of the invention include providing multi-user participation in an application over a network. The systems and methods include providing for a user to affect a virtual state of an application on a network; determining a safe latency for the user; determining a field of influence and a field of commitment based upon the determined safe latency; permitting the user input to affect a field of influence and prohibiting the user from affecting the field of commitment; and displaying the virtual state of the application, wherein the virtual state includes the field of influence and field of commitment, and wherein a portion of the field of influence becomes the field of commitment after the determined safe latency has expired.

Further principles consistent with the invention provide for methods and systems for compensating for network latencies, including determining latencies of a network associated with each client in a multi-client application; computing, based upon the latencies for each client, first states configured to receive client input; computing, based upon the latencies for each client, second states unaffected by client input; and re-computing the first states and the second states for each client as the application progresses.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 is an exemplary system environment for implementing the features of the present invention;

FIG. 2 is an exemplary diagram of the components of a server computer, consistent with the principles of the present invention;

FIG. 3 is an exemplary diagram of the components of a client device, consistent with the principles of the present invention;

FIG. 4 depicts an exemplary flow diagram of the steps performed in establishing game play consistent with the principles of the present invention;

FIG. 5 depicts an exemplary screen display of a map viewed by a user playing a game consistent with the principles of the present invention;

FIG. 6A depicts an exemplary screen display of a map viewed by a user playing a game consistent with the principles of the present invention;

FIG. 6B depicts an exemplary screen display of a map viewed by a user playing a game consistent with the principles of the present invention; and

FIG. 6C depicts an exemplary screen display of a map viewed by a user playing a game consistent with the principles of the present invention.

### DETAILED DESCRIPTION

Reference will now be made in detail to the features of the principles of the present invention, examples of which are illustrated in the accompanying drawings. Wherever possible, the same reference numbers will be used throughout the drawings to refer to the same or like parts.

The present invention relates generally to methods and systems for facilitating multi-user interaction in a network environment. In systems consistent with the present invention, multiple users communicate through a networked environment to access a multi-user application. For exemplary purposes, the disclosure herein is directed to an on-line game. It should be understood, however, that the architecture and principles of operation of the on-line application are applicable to a variety of applications and certain principles of the invention are not limited to the on-line game described herein.

It may be appreciated that the phrase “system latency”, when used throughout the disclosure, may include the system delay in transmitting data and may further include the delay based on having to resend information due to lost packets or a failure to receive an acknowledgement. It may further be appreciated that system latency may include a delay based upon a disconnected device reconnecting to the network.

System Architecture

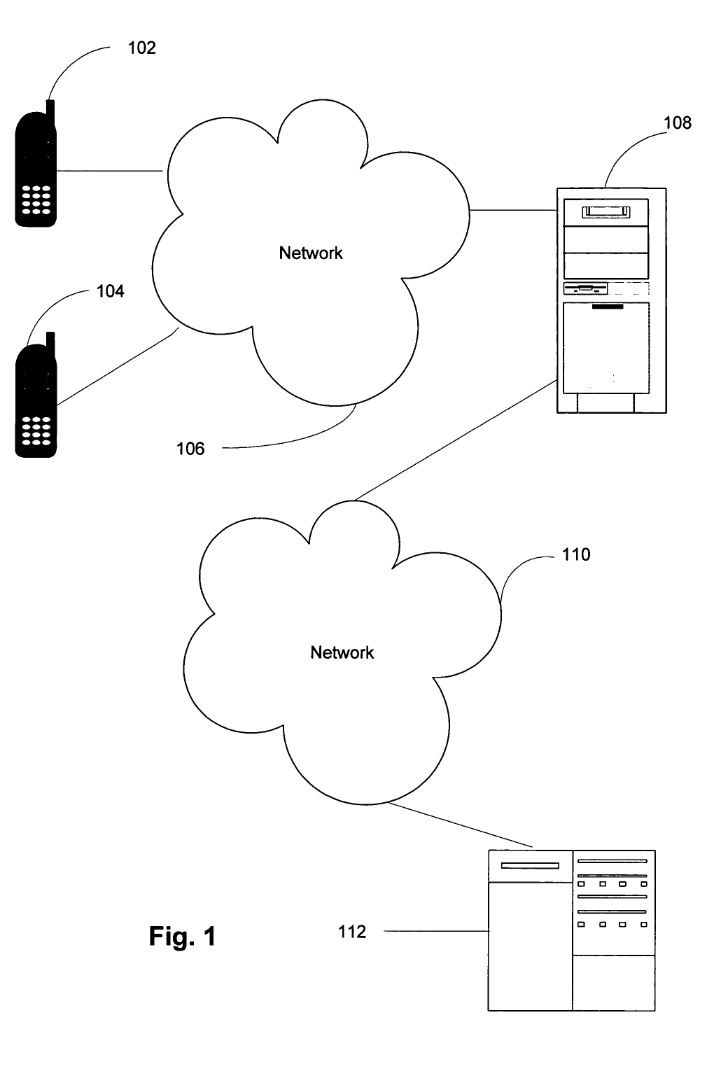

FIG. 1 is an exemplary diagram of a system environment 100 for implementing the principles of the present invention. The components of system 100 can be implemented through any suitable combinations of hardware, software, and/or firmware. As shown in FIG. 1, system 100 includes a plurality of client devices 102 and 104 communicating with network gateway 108 via network 106 where network gateway 106 facilitates communication between client devices 102 and 104 and server computer 112 through network 108. While only two client devices are depicted in FIG. 1, it may be appreciated by one of ordinary skill in the art that more than two client devices may operate within the system environment. Network 106 may be implemented as a cellular network while network 108 may be the Internet. It may further be appreciated that network 108 may be implemented as any local or wide area network, either public or private. It may further be appreciated that additional server computers or client devices, i.e., client computers, may reside on network 110. It may further be appreciated that there may be additional networks operating in environment 100 wherein additional client devices may interact with server 112. It may further be appreciated by one of ordinary skill in the art that one of the client devices may act as server 112.

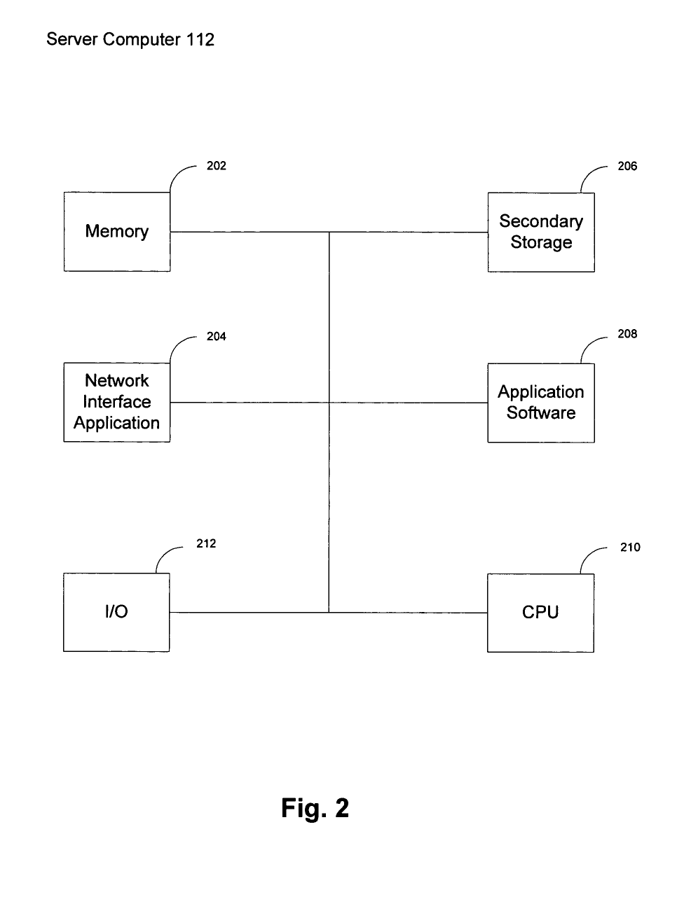

FIG. 2 depicts an exemplary block diagram of server computer 112 that may be implemented in system environment 100, consistent with the principles of the present invention. As shown in FIG. 2, server computer 112 includes memory 202, network interface application 204, secondary storage 206, application software 208, central processing unit (CPU) 210 and input/output devices 212. Input/output devices 212 may include, for example, a keyboard, a mouse, a video cam, a display, a storage device, and/or a printer. Server computer 112 may be communicably linked with client devices 102 and 104 to provide access to applications stored in application software 208. Additionally, server computer 112 may be communicably linked to network gateway 106 to facilitate communication with client devices 102 and 104. Application 208 stores a multi-user application, which may be accessed by client devices 102 and 104.

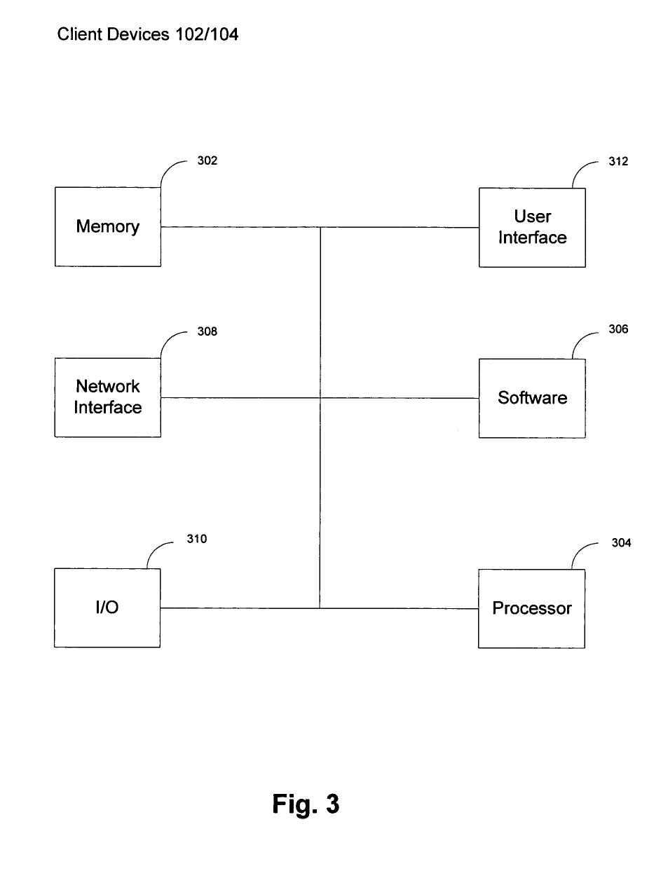

FIG. 3 depicts an exemplary block diagram of client devices 102 and 104 that may be implemented in system environment 100, consistent with the principles of the present invention. Client devices 102 and 104 are described herein within the context of a cellular telephone. However, it may be appreciated by one of ordinary skill in the art that other types of wireless or wired devices may be implemented. For example, client devices 102 and 104 may be implemented using a Personal Digital Assistant (PDA), a pager, a personal computer, or any other device that is capable of operating on either network 106 or network 108.

As shown in FIG. 3, client devices 102 and 104 may include, for example, memory 302, processor 304, software 306, network interface 308, input/output devices 310, and user interface 312. A user may, through user interface 312 and network interface 308, access server 112 through networks 106 and 110. User interface 312 may be implemented as any conventional browser application to facilitate interaction with applications on server 112 on network 110. A user may launch user interface 312 through input/output devices 212 and access server 112 through networks 106 and 110. Input/output devices 310 may include, for example, a keypad, a video cam, a display, and a storage device. Client devices 102 and 104 may operate on a variety of platforms including Java-J2ME(MIDP), Brew, Ex-en, MoPhun, Symbian, Windows, Macintosh, and Linux.

It may be appreciated by one of ordinary skill in the art that while the disclosure herein is directed to a client/server environment, principles consistent with the present invention may be implemented in a peer-to-peer environment.

Application Access and Setup

As noted above, system environment 100 enables client devices 102 and 104 to access a multi-user application on server 112. For exemplary purposes, the multi-user application will be discussed within the context of an on-line game. While the software application is being described with regard to client device 102, it can be appreciated that the functionality of client device 104 is similar to the functionality described for client device 102.

Once the client has installed the necessary software to run the multi-user application, the user may manually launch the application from client device 102. Alternatively, the application may be launched by client device 104. The user may be required to sign on to the application with a user name and a password in order to play the game. Should the user input an incorrect user name and/or password, the user may be denied access to the game play.

Alternatively, or in addition to the above, the user may gain access to the application upon determination and verification of the user's telephone number as determined by the system.

Upon verification of the user name and password, the user may have the opportunity to configure game play. For example, the user may have access to a main menu, which provides the user with a number of options including Help, Play, Information, People/Buddies, and Setup. The People/Buddies menu option allows the user to either send or receive messages to other users. The Information menu option provides the user with information regarding how to play the game, statistics, (i.e., the user's wins, losses, games, current level, rank, etc.) and community news. A community news broadcast provides the user with information regarding other users in connection with the game, for example, other users winning games, other users reaching new levels, etc. This information may be limited to information regarding other users that the user has a relationship with. Game hints, system messages, user-to-user messages, and community news broadcasts are examples of the type of information that may be shown in Information Display panels that may be located on the display screen of the client device.

The Play menu option provides the user with a selection regarding the type of the play the users wants to play. These different types of play are discussed below. The practice option allows a user to practice the game without being in competition with other users. The Custom option allows a user to select a Custom game. Custom play will be discussed below. In the Information Menu option the user has a number of additional options including How to Play, My Statistics, Community, and News. These options may be similar to the options discussed above.

The People option provides the user with a number of options including Messages Waiting, Buddies, Opponents, Non-players, and Setup. The Messages Waiting option allows a user to view headings of messages sent to the user and are waiting to be viewed. The user may view these messages through the game interface. The user may navigate through the headings to read the messages and may be able to sort the messages through a variety of algorithms including date, alphabetically by subject or sender, etc. The game further allows a user to maintain information regarding the user's buddies. The user may access this information by selecting the Buddies option. This list includes players with which the user has a relationship. In this menu option, buddies may be added or removed, and any information regarding buddies may be added, modified or removed. Information regarding buddies may include location, wins, current level, highest level achieved and date achieved, record versus buddy, and communication information which may include AOL Instant Messaging address, SMS address, ICQ address, MS Messenger address, and e-mail address. A user may further chat with a buddy or invite a buddy to play a game. Should a user wish to invite one or more buddies to play in a particular game room, the user may contact the buddies through this menu option.

The Opponents menu option allows a user to obtain information about prior opponents and further allows a user to communicate with prior opponents. This menu item may be similar to the Buddies option discussed above. The Non-Players option allows a user to invite non-players into a game. The Setup option allows a user to configure People settings, including add, delete, block, unblock, etc.

The Setup menu from the main menu provides for a user to setup information regarding the animated graphics. Upon selecting the Setup menu option, the user has additional options to select including Profile, Buddies, Account, character, sound, network, and Help. The Account option allows a user to select a handle, or a game name identifier. The application may limit users to one handle may be allowed per account or telephone number. The user may change their handle if the new handle selected by the user has not been reserved by another user. Once the change is confirmed, the discarded handle remains blocked for a period of time. After the period of time expires, the discarded handle may become available for other users to register. The number of changes of a handle may be limited within a period of time. The Preferences option allows the user to select the character, or sprite, the user wishes to use in game play. The audio sound, type of music, and sound effects may also be selected using this menu option.

The Communications menu allows a user to communicate with other users before, during, or after a game. Through this menu, a user may send and receive communications from other users. These communications may include an invitation to join a Custom game. In response to a receipt of an invitation to join a Custom game, the user may accept or decline. Additionally, these communications may be implemented as a directed or broadcast message to players that appear in the information display 504. Additionally, the user is able to send direct or voice messages other players before, during, or after a game. These messages may include voice, text, image, or video data. This may be accomplished by the cellular telephone receiving the voice data, image data, text data, or video data, digitizing the message, compressing the message and streaming the message with data packets transmitted from the cellular telephone.

The Buddies menu allows a user to add, delete, or modify information relating to the user's buddies. Additionally, the user, through client device 102 has the ability to ask the system to see if any of the user's buddies are currently an on-line application player or if they are currently accessing the application. To facilitate this, the server may upload the user's buddy list, the names and information of the buddies currently stored by the user. Based upon the telephone numbers, or other identifying information stored in the buddy list, the system may determine if any of the buddies are currently users of the application. If not, the system may send a message inviting the buddy to access the application. If they are currently users of the application, the system may determine what rooms the buddies are located in and forward that information to client device 102.

In addition to the features discussed above, the user has the ability to create, edit, maintain, and access a Buddy list. This Buddy list may include a list of other users to which the user has a relationship.

The system has the ability to create and maintain a game lobby, implemented to a “chat room”, wherein a user may invite his buddies to join him. In the game lobby, the users may chat between themselves. Additionally, the user may, through input/output devices 212, generate a message that may be sent to other users during the game. The user may create the message for a targeted audience, namely to one or more particular individuals. Alternatively, the user may broadcast the message where the message would be received by all users on the network.

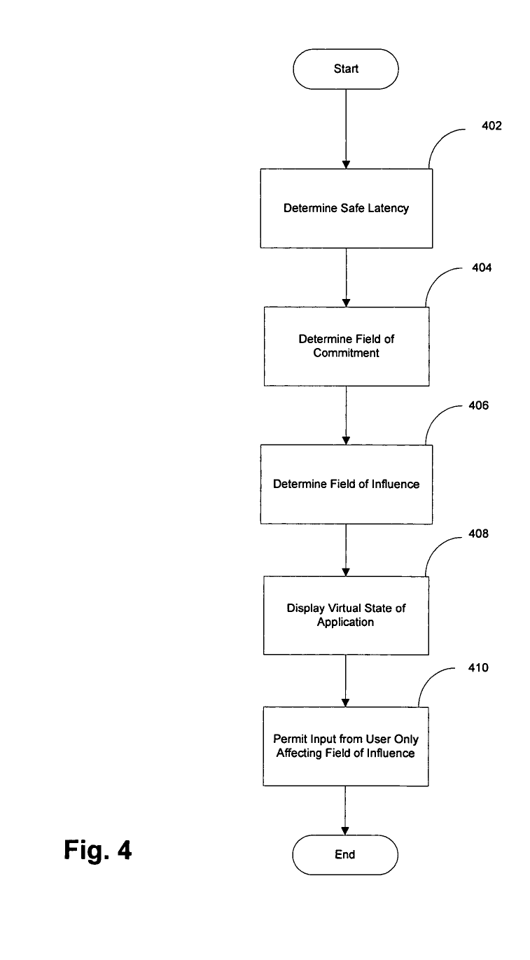

The user may request the system implement a Custom game with the buddies that are in the game lobby. Once in a game or lobby together, the users may communicate with one another using, for example, text, voice, images, or video. This data may appear in the info display portion 408 as shown in FIG. 4. The user is not limited to chatting with the other users in the game. The user may alternatively chat with other buddies, or other opponents. Using the Buddy feature, the user may have the ability to see if the buddy is currently located in a particular room. Additionally, the user may have the ability to categorize buddies. The system may further have the ability to incorporate information from a third-party buddy system, i.e., America On-Line, Microsoft, and Yahoo. Alternatively, the user may have the option to add buddies based upon a list of people stored in client device 102. The user may have the option to have the system upload the list of people stored in the address portion of the cellular telephone. The system may then, using the telephone numbers associated with the people's name, invite the people to access the multi-user application by sending a communication. For example, if the user has a friend, Joe, stored in the address portion of the cellular telephone, server 112 may communicate with Joe via the stored telephone number asking Joe if he wants to play a game. If Joe accepts, his telephone number becomes his identification number and Joe can join in a game. Additionally, Joe's name and telephone number may be input into the user's buddy list.

The Play option allows a user to select Quickplay, Practice or Custom. The Practice selection allows a user to practice playing the game in order to learn the controls and the features of the game and is discussed above. During Quickplay, a group of players are selected from users waiting to play the game. The group may be of any predetermined size ranging from, for example, five to eight players. If the group has fewer than the predetermined size, the group may be considered open. If the group has the predetermined number of players, then the group may be considered closed. The system may operate as many games as there are players to fill a game room. If a user logs on and selects the Quickplay option, the system searches the game rooms for a group that is open. If no game rooms are open, a new game room may be created. Games that are open may be combined to provide for a game that is closed. Rooms may be filled by the system randomly, or based upon certain predetermined criteria, i.e., skill level, prior opponent relationships, namely, the players have played against each other before, players with common buddies, etc. After the Quickplay game is over, the users leave the virtual game room and enter another virtual room that may be considered a lobby where the users may chat with each other, i.e., by voice, by text, or by video. In this virtual lobby, any player may enter and chat, regardless of whether the user was invited by another player. From this lobby, a user may enter another game, or enter another lobby by selecting the appropriate command discussed above.

A Custom game may be created by a user. In creating a Custom game, the user selects from a variety of options including free-for-all, teams, and tournament. Additionally, the user may select who may play via Buddy lists and invitations. For example, the user may select that anyone can join, only those approved by the game owner, or only those invited by the game owner. The user additionally selects the scoring of the game. For example the user may select last man standing, point goal, timed game, capture the flag, tag, league, wager (points), and scrimmage (no score). The user may additionally select the maximum number of players and whether or not players may join after the game has started. Further, the user may select the power-up frequency and additional custom settings. Finally, the user may select an official map or may select to upload a new map. After a Custom game is over, the users leave the virtual game room and enter another virtual room that may be considered a lobby where only the Custom players may enter. Generally, players that either created the Custom game, or were invited to play the Custom game may enter and chat in a Custom lobby. Additionally, if a user's buddy is playing in a Custom game room, the user may join the buddy in the Custom game. From this lobby, a user may enter another game or enter another lobby by selecting the appropriate setup command. Additionally, a user may access the user's buddy list to invite a buddy to join a Custom game.

Each game room may have a level number associated with the room indicating the level of difficulty of game play. Alternatively, a point system based on prior accomplishments of the user may be implemented.

Regardless of the game being played, after game play, the user may enter a game lobby. While in the game lobby, the user may add any of the players playing the previous game to the user's buddy list.

Server computer 112 may generate a random map based on certain preset characteristics. The map may be displayed in the game room as the user is playing the game. These characteristics may be based upon the level of difficulty associated with the game. These characteristics may include average corridor length, number of intersections, etc. Characteristics may alternatively be based upon the ability to upload a map or the selection of a Custom map.

Latency

In order to provide the user with an on-line game that maintains a consistent representation of the virtual environment, accurately depicting the user and the user's opponent's moves on the display, latency may be considered. FIG. 4 depicts an exemplary flow diagram of the steps performed in establishing game play consistent with the principles of the present invention. As shown in FIG. 4, using conventional techniques, the network latency is calculated (Step 402). For example, a round-trip packet may be transmitted from client device 102 to server computer 112 and then back to client device 102. The total travel time of the packet may be determined. This travel time constitutes the network latency. The latency may be calculated only once prior to game play, it may be calculated at predetermined time intervals, or it may be calculated for every packet sent in order to adjust for latency fluctuation.

Latency may alternatively be measured at the beginning of each game, or measured independently of a game. The game operator may then determine the “safe latency” based on: average round-trip ping times, peak ping times, jitter, packet loss, retries, disconnects, etc. For example, the game operator might analyze network performance data, and decide that 99% of all game packets will be successfully transmitted in less than 4 seconds. To add a buffer, the game operator might add a second of time to the buffer, making the “safe latency” 5 seconds. The game uses this “safe latency” metric to define the field of commitment. Thus, a safe latency may be a time period where the system can ensure that the input provided by a user may be timely received, processed by the server, and communicated back to other client devices. This safe latency may be applied to all users within the game to ensure a fair game.

A field of commitment may be based upon the safe latency determined by the system (Step 404). The field of commitment represents a period of time during game play that the user's input cannot affect. The field of commitment may be implemented graphically where the multi-user application is two-dimensional game where players move through a map at a constant speed, thus translating time into space. The field of commitment may be graphically represented as a portion of the map to indicate a space on the map that is unable to be affected by user input. The user is unable to affect game play during the safe latency period. In other words, the user is unable to affect the current state of game play. A field of influence may be also based upon the safe latency determined by the system (Step 406). The field of influence may be implemented graphically where the multi-user application is two-dimensional game where players move through a map at a constant speed, thus translating time into space. The field of influence may be graphically represented as a portion of the map to indicate a space on the map that the user's input may affect. The field of influence and the field of commitment may not overlap. The field of influence may be that portion of the map that is outside the safe latency of the game. A map that indicates the field of commitment and field of influence may be displayed (Step 408). The user input that is received by the system affects the field of influence (Step 410), or the future state of the virtual game, not the field of commitment, or the current state of the virtual game. Thus, where the safe latency is five seconds, the field of influence is more than five seconds in the future game play.

In other words, the user can affect the game state, but not immediately. The user is only allowed to take actions outside of his/her field of commitment. By requiring the player to play in the future, the client software tells the server about upcoming moves (in this example, that means moves five seconds or more in the future). This advance notice should give the server time to inform all other clients about the upcoming move before it occurs. By the time a user reaches a decision point, all other users will already know what decision he/she will take. If a player fails to make a decision, and the upcoming decision point moves into the players field of commitment, the client or server may make a decision for the user. This decision made by the server may be considered a “default move”.

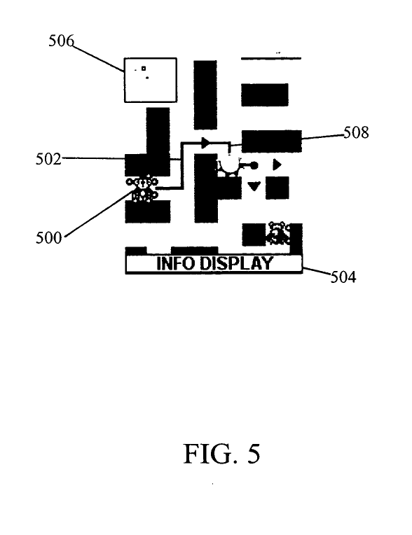

FIG. 5 depicts an exemplary map that a user may play on upon entry into a game room. As shown in FIG. 5, a series of walls and paths are depicted. The sprite 500 that the user selects is guided through the map based upon commands that are received from the user. Prior to, and possibly during, game play, the system determines the network latency. Based upon the network latency, a safe latency is determined. For exemplary purposes, suppose the safe latency is five seconds. Based upon safe latency, a field of commitment is determined to be five seconds of movement of the sprite 500. As shown in FIG. 5, line portion 502, depicted by a solid blue line with an arrow represents a field of commitment. It may be appreciated by one of ordinary skill in the art that any graphic representation may be implemented where the field of commitment is graphically different from the field of influence. It may further be appreciated that the field of commitment and the field of influence may not be graphically represented. Line portion 502 represents the path the sprite will travel in the next five seconds. During the travel of the sprite through the path indicated by line portion 502, the user will be unable to affect the game play. In other words, the sprite 500 is committed to the path of line portion 502.

Line portion 502 remains the same length until such time that the network latency and safe latency may be recalculated. Should the safe latency be re-determined to be, for example, six seconds, the line portion will appear longer where the sprite would take six seconds to traverse the length of line portion 502, the field of commitment, or the speed of the sprite may be slowed. This time to traverse the length of the line may vary based upon the length of the line and the speed of the characters. Further, line portion 502 may be the same length for all players. In other words, the field of commitment, based upon the determination of the safe latency, may be the same for all players in order to ensure a fair game.

Line portion 504 represents the user's field of influence. Line portion 504 includes, for example, a solid red portion, and two arrows indicating possible paths available to the user. It may be appreciated by one of ordinary skill in the art that any graphic representation may be implemented where the field of commitment is graphically different from the field of influence. It may further be appreciated that the field of commitment and the field of influence may not be graphically represented. These red arrows appear at decision points in the map. As shown in FIG. 5, one arrow appears red and the other arrow appears black. Once the user makes a selection using input/output devices in client device 102, the path selected by the user may fill in with the line portion 404 and the next decision point in the map will be highlighted by the two arrows, one red and one black. However, if the user does not provide input within the field of influence, the default direction will be selected by the system. In the example shown in FIG. 5, the black arrow represents the default direction. It may be appreciated that the graphic representation of the two arrows indicating possible paths available may be implemented as any graphic representation that may indicate the possible options to the user.

As the sprite 500 travels through the map, line portion 502 becomes the tail portion of line portion 504. In other words, the field of influence eventually becomes the field of commitment as time passes.

The display depicted in FIG. 5 further includes radar 506 indicating the position of all characters, or sprites, in the map. Further, info display 508 is depicted and may display a variety of types of information, including messages between players, the status of the game currently being played, the status of other games being played, game metrics (i.e., time left for play), etc. Additionally, info display 508 may be scrollable, wherein a predetermined number of messages are buffered and may be scrolled for viewing.

The map may be larger than the display of client device 102. As such, the user additionally has the ability to scroll to other parts of the map.

It may be appreciated by one of ordinary skill in the art that, within the field of influence, a user may undo a decision that was previously decided. For example, if the user decides to go left at a decision point, and then decides to go right, as long as the decision point remains in the field of influence, the user may be able to change the decision.

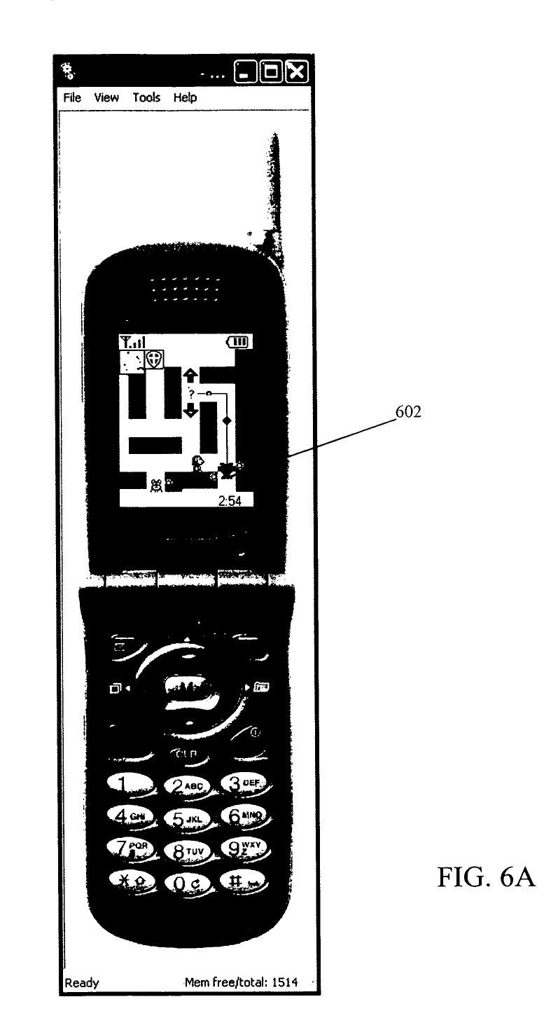

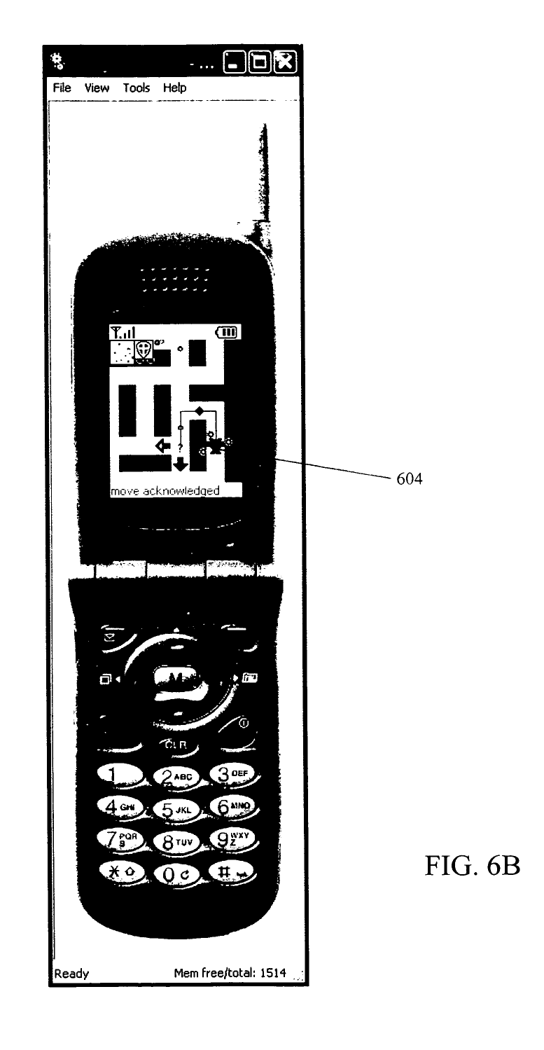

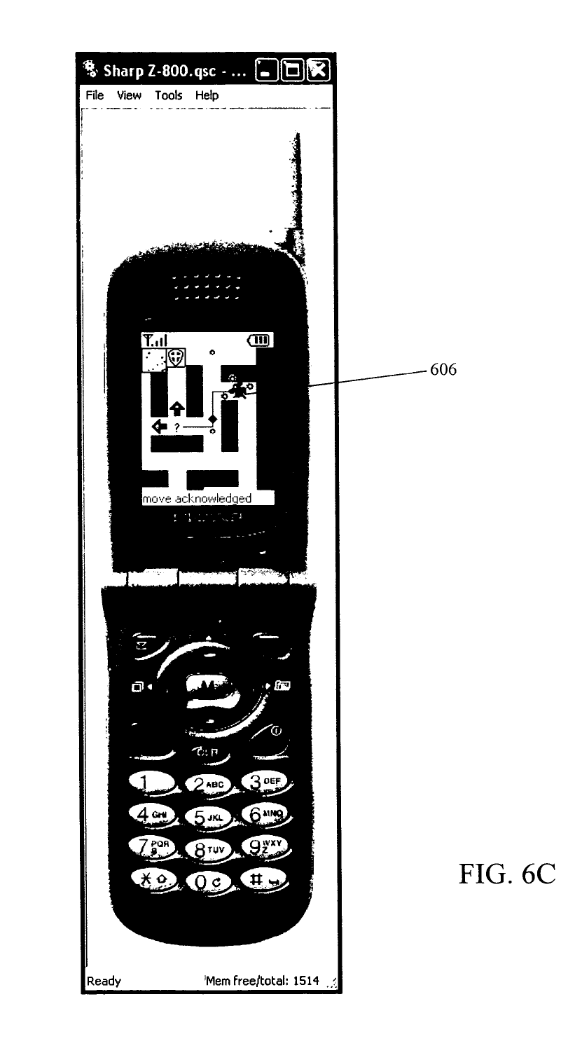

FIGS. 6A-6C depict an exemplary screen display of a map viewed by a user playing a game. FIGS. 6A-6C represent the same game being played at three successive points in time. The line portion between the sprite and the diamond represent the field of commitment. The user is unable to affect the path of the sprite within the field of commitment. The line portion between the diamond and the two arrows represents the field of influence.

As shown in FIG. 6A, sprite 400 is located at point 602 and is traveling north at a constant speed. The two arrows, one pointing north and one pointing south, represent the user's first decision point. As the sprite is traveling north, the system waits for input from the user as to whether the user wishes to travel north or south. The system waits until the decision is no longer within the field of influence to receive input from the user. If the user does not input a response selecting either north or south, a default path is selected by the system. In this example, the user selected to go south.

As shown in FIG. 6B, a point in time later than shown in FIG. 6A, the sprite is located at point 604 and is still traveling north. The decision point depicted in FIG. 6A is now represented in FIG. 6B as part of the path the sprite will travel. The next decision point in the map is indicated by two arrows, one pointing south and one pointed west. The system again waits to receive the user's input selecting either south or west. In this example, the user selects to travel west.

As shown in FIG. 6C, a point in time later than shown in FIG. 6B, the sprite is located at point 606 and is now traveling west. The decision point depicted in FIG. 6B is now represented in FIG. 6C as part of the path the sprite will travel. The next decision point in the map is indicated by two arrows, one pointing north and one pointed west. The system again waits to receive the user's input selecting either south or west.

Game Play

As the sprite 500 moves through the map, coins, appearing at random locations on the map, may be collected. Coins may move through the map at a slower pace than characters, or sprites. At the beginning of the game, a predetermined number of coins are spawned. If a coin is collected, another coin may be spawned to taken the collected coin's place. If a character, or sprite collides with the coin, the user's coin count increases. The coin count may be visually represented on the display. As shown in FIGS. 6A-6C, the coins appear connected to sprite 400.

If two or more characters, or sprites occupy the same space in the map, a collision occurs. When this occurs, the sprite that has the most coins wins the collision and continues on his path. The loser sprite is teleported to a new map location, initially in Ghost mode, where the character is translucent. Additional characteristics of the Ghost mode are discussed below. If the loser had any coins, the collision jars one coin loose. If both sprites have the same number of coins, it is considered an elastic collision, the sprites retain their respective coins, and each sprite's path rotates 180 degrees. A sprite with a full set of coins looses collisions against players with fewer coins. The loser may be teleported to a new map location appearing, initially in Ghost mode. The collision jars one coin loose from the loser.

The system further may generate power-ups for enhanced game play. Power-ups allow sprites to execute special moves. The following are exemplary power-ups:

Ghost: Mass becomes zero, so sprites pass through each other on the next collision, as if the collision had never occurred.

Shield (Bounce): Next collision becomes elastic (each sprites' path rotates 180 degrees). No coin loss for either sprite when shielded collisions occur.

Teleport (Hyperspace): After a predetermined time interval, the user is relocated to a random point on the map.

Reverse: After a predetermined time interval, the sprite's direction rotates 180 degrees.

Stall Bomb: When a sprite drops a stall bomb, the next sprite that runs over the stall bomb looses speed for a predetermined time interval.

Coin Bomb: When a sprite drops a coin bomb, the next sprite who runs over the coin bomb loses a coin. The lost coin is spawned at a random location on the map.

These exemplary power-ups may be randomly spawned on the map at random or predetermined time intervals. There may be a maximum number of power-ups that are spawned for a particular game. Additionally, some power-ups may be immediately activated where once a play chooses a path to power-up, the server may communicate inevitability to other clients. Other power-ups may only be activated outside the field of commitment.

When a player collects a full set of coins, his exit portal is opened on the map. A user wins the game when his sprite exits through the exit portal. The server selects a point on the map for the portal that is far away from the sprite's position. If the user navigates his sprite successfully through the map without loosing any coins, the user wins and the game is over. The player's level may increase or the player may accumulate points. All players are sent to a post-game mode. If the sprite collides with another sprite, and looses a coin, the exit portal disappears.

The game may be implemented as a timed game. If the time expires without any user collecting a full set of coins and successfully exiting through the exit portal, the game ends in a stalemate.

As noted above, client devices 102 and 104 may include a variety of devices including a cellular telephone, a PDA, or a personal computer. Although the graphics may appear differently between client devices, the amount of the map displayed on each client device may be the same.

Error Management

Conventional techniques may be implemented in accommodating errors that occur during game play. In addition to the conventional techniques, principles consistent with the present invention provide for concatenating data. For example, data is sent to the client in sequenced packets. If the system does not get an acknowledgement that a packet has been received, in order to reduce the number of packets that have to be sent to maintain a current game state, the system may concatenate subsequent packets together into a single packet, maintaining packet order, so that once the troublesome packet is acknowledged, the backlog can be cleared rapidly. Alternatively, the system may manage session identification cookies per user instead of managing Internet Protocol (IP) addresses per user. Thus, if the client device disconnects, even though the client device has a different IP address, there would be no interrupt in game play if the client reconnects, as the client would have the same session cookie.

Further, consistent with the principles of the present invention, if the client device has disconnected, and the sprite is not located in the appropriate location, namely where the server has tracked the sprite, when the client device is reconnected, the system may teleport the sprite to the accurate location. Alternatively, if another player is at an intersection and the system has not received information from another player regarding the player's decision, the sprite may march in place until data is received. When the data is received, the sprite may then run to the appropriate place. Alternatively, if no data is received, the sprite may split into two sprites and travel both paths until data is received. When the data is received the sprite that traveled the unselected path may disappear.

It can be appreciated that while the graphical representations described herein include a detailed discussion of appearances, it can be appreciated by one of ordinary skill in the art that different graphical representations may be implemented. Further, it can be appreciated that an off-line version of the game described herein may be played without a connection to any network. In this situation, the server 112 may control the opponents. It may further be appreciated that the principles discussed herein relating to compensating for latency may be applied to other multi-user on-line applications and are not limited to the on-line game discussed herein. It may further be appreciated that while the figures disclosed herein are directed to a two-dimensional on-line application, different applications may be implemented, i.e., three-dimensional on-line applications.

Modifications and adaptations of the invention will be apparent to those skilled in the art from consideration of the specification and practice of the invention disclosed herein. It is intended that the specification and examples be considered as exemplary only, with a true scope and spirit of the invention being indicated by the following claims.

1. A method for providing multi-user participation in an application over a network comprising:
providing for a user to affect a virtual state of an application on a network;
determining a safe latency for the user;
determining a field of influence and a field of commitment based upon the determined safe latency;
permitting the user input to affect a field of influence and prohibiting the user from affecting the field of commitment; and
displaying the virtual state of the application,
wherein the virtual state includes the field of influence and field of commitment, and
wherein a portion of the field of influence becomes the field of commitment after the determined network latency has expired.

2. The method of claim 1, wherein the field of influence and the field of commitment are displayed.

3. The method of claim 1, wherein the field of influence and the field of commitment are two-dimensional.

4. The method of claim 1, wherein the field of commitment is displayed graphically different than the field of influence.

5. The method of claim 3, wherein the field of commitment is displayed in a first color and wherein the field of influence is displayed in a second color.

6. The method of claim 4, wherein the displayed field of commitment is represented by a line that represents a path wherein the user is committed.

7. The method of claim 1, wherein displayed field of influence includes a graphic indicating options available to the user.

8. The method of claim 6, wherein the graphic indicating options available to the user is at least two arrows indicating the possible directions available to the user.

9. The method of claim 1, wherein users operate on different hardware platforms.

10. The method of claim 1, wherein the user may communicate with at least one other user or invite the other user to access the application, wherein the communication may be made by at least one of voice, text, image, or video data.

11. A computer-readable medium containing instructions, executed by a processor, for performing a method of providing multi-user participation in an application over a network comprising:
providing for a user to affect a virtual state of an application on a network;
determining a safe latency for the user;
determining a field of influence and a field of commitment based upon the determined safe latency;
permitting the user input to affect a field of influence and prohibiting the user from affecting the field of commitment; and
displaying the virtual state of the application,
wherein the virtual state includes the field of influence and field of commitment, and
wherein a portion of the field of influence becomes the field of commitment after the determined safe latency has expired.

12. The computer-readable medium of claim 11, wherein the field of influence and the field of commitment are displayed.

13. The computer-readable medium of claim 11, wherein the field of influence and the field of commitment are two-dimensional.

14. The computer-readable medium of claim 11, wherein the field of commitment is displayed graphically different than the field of influence.

15. The computer-readable medium of claim 13, wherein the field of commitment is displayed in a first color and wherein the field of influence is displayed in a second color.

16. The computer-readable medium of claim 11, wherein the displayed field of commitment is represented by a line that represents a path wherein the user is committed.

17. The computer-readable medium of claim 11, wherein displayed field of influence includes a graphic indicating options available to the user.

18. The computer-readable medium of claim 16, wherein the graphic indicating options available to the user is at least two arrows indicating the possible directions available to the user.

19. The computer-readable medium of claim 11, wherein users operate on different hardware platforms.

20. The computer-readable medium of claim 11, wherein the user may communicate with at least one other user or invite the other user to access the application, wherein the communication may be made by at least one of voice, text, image, or video data.

21. An apparatus for providing multi-user participation in an application over a network comprising:
a memory storing a program; and
a processor responsive to the program to:
provided for a user to affect a virtual state of an application on a network;
determine a safe latency for the user;
determine a field of influence and a field of commitment based upon the determined safe latency;
permit the user input to affect a field of influence and prohibiting the user from affecting the field of commitment; and
display the virtual state of the application,
wherein the virtual state includes the field of influence and field of commitment, and
wherein a portion of the field of influence becomes the field of commitment after the determined safe latency has expired.

22. The apparatus of claim 21, wherein the field of influence and the field of commitment are displayed.

23. The apparatus of claim 21, wherein the field of influence and the field of commitment are two-dimensional.

24. The apparatus of claim 21, wherein the field of commitment is displayed graphically different than the field of influence.

25. The apparatus of claim 24, wherein the field of commitment is displayed in a first color and wherein the field of influence is displayed in a second color.

26. The apparatus of claim 21, wherein the displayed field of commitment is represented by a line that represents a path wherein the user is committed.

27. The apparatus of claim 21, wherein displayed field of influence includes a graphic indicating options available to the user.

28. The apparatus of claim 27, wherein the graphic indicating options available to the user is at least two arrows indicating the possible directions available to the user.

29. The apparatus of claim 21, wherein users operate on different hardware platforms.

30. The apparatus of claim 21, wherein the user may communicate with at least one other user or invite the other user to access the application, wherein the communication may be made by at least one of voice, text, image, or video data.

31. A method of compensating for network latencies, comprising:
determining a safe latency associated with a client in a multi-client application;
computing, based upon the determined safe latency for the client, a first state configured to receive client input;
computing, based upon the determined safe latency for the client, a second state unaffected by client input; and
re-computing the first state and the second state for the client as the application progresses.

32. The method of claim 31, wherein the first state and the second state represent virtual spatial dimensions.

33. The method of claim 32, wherein the spatial dimensions are two dimensional.

34. The method of claim 32, wherein the first state corresponds to a field of influence and the second state corresponds to a field of commitment.

35. The method of claim 34, further comprising:
displaying the field of influence and the field of commitment; and
transforming a portion of the field of influence into the field of commitment after the determined safe latency has expired.

36. The method claim 35, wherein the field of influence and the field of commitment are distinguished by different graphical representations.

37. The method of claim 31, wherein the clients include different hardware platforms.

38. The method of claim 37, wherein a first client comprises a personal computer and a second client comprises a portable device.

39. A computer-readable medium containing instructions, executed by a processor, for performing a method of compensating for network latencies, comprising:
determining a safe latency associated with a client in a multi-client application;
computing, based upon the determined safe latency for the client, a first state configured to receive client input;
computing, based upon the determined safe latency for the client, a second state unaffected by client input; and
re-computing the first state and the second state for the client as the application progresses.

40. The computer-readable medium of claim 39, wherein the first state and the second state represent virtual spatial dimensions.

41. The computer-readable medium of claim 39, wherein the spatial dimensions are two dimensional.

42. The computer-readable medium of claim 39, wherein the first state corresponds to a field of influence and the second state corresponds to a field of commitment.

43. The computer-readable medium of claim 41, further comprising:
displaying the field of influence and the field of commitment; and
transforming a portion of the field of influence into the field of commitment after the determined safe latency has expired.

44. The computer-readable medium claim 42, wherein the field of influence and the field of commitment are distinguished by different graphical representations.

45. The computer-readable medium of claim 39, wherein the clients include different hardware platforms.

46. The computer-readable medium of claim 45, wherein a first client comprises a personal computer and a second client comprises a portable device.

47. An apparatus for compensating for network latencies, comprising:
a memory storing a program; and
a processor responsive to the program to
determine a safe latency associated with a client in a multi-client application;
compute based upon the determined safe latency for the client, a first state configured to receive client input;
compute based upon the determined safe latency for the client, a second state unaffected by client input; and
re-compute the first state and the second state for each client as the application progresses.

48. The apparatus of claim 47, wherein the first state and the second state represent virtual spatial dimensions.

49. The apparatus of claim 48, wherein the spatial dimensions are two dimensional.

50. The apparatus of claim 48, wherein the first state corresponds to a field of influence and the second state corresponds to a field of commitment.

51. The apparatus of claim 50, further comprising:
displaying the field of influence and the field of commitment; and
transforming a portion of the field of influence into the field of commitment after the determined safe latency has expired.

52. The apparatus claim 47, wherein the field of influence and the field of commitment are distinguished by different graphical representations.

53. The apparatus of claim 47, wherein the clients include different hardware platforms.

54. The apparatus of claim 53, wherein a first client comprises a personal computer and a second client comprises a portable device.

55. The method of claim 1, wherein the method further includes:
transmitting data in sequenced packets to the user;
determining a packet has not been received in a timely manner by the user; and
reducing the number of packets to be sent to clear a backlog of subsequent packets by concatenating the subsequent packets together.
